(19) United States
(12) Patent Application Publication
(10) Pub. No.: US 2004/0099654 A1
(43) Pub. Date: May 27, 2004

(54) Surface heating device and method

(76) Inventor: Aaron Pais, Oakville (CA)

Correspondence Address: Aaron PAIS, c/o PROTECTIONS EQUINOX INT'L INC., 4480, Cote-de-Liesse, Suite 224, Montreal, QC, H4N 2R1, CA

(21) Appl. No.: 10/300,628

(22) Filed: Nov. 21, 2002

(51) Int. Cl. H05B 1/02; H05B 3/02

(52) U.S. Cl. 219/486; 219/213

(57) ABSTRACT

A heating device for heating a surface, in which the surface defines a plurality of predetermined areas. The heating device is electrically connectable to a power source and comprises heating circuit in communication with the surface for communicating heat to the surface. The heating circuit includes a plurality of heaters, each of which covers the respective predetermined areas. The heaters are electrically independent from one another. The alternating circuit is electrically connected to the plurality of heaters and electrically connects them to the power source. The alternating circuit alternately powers the heaters at a selected time interval so as to alternately heat each of the respective predetermined areas of the surface. There is also provided a method of using the heating device to heat the surface.

### FIELD OF THE INVENTION

The present invention concerns heating devices, more particularly heating devices for heating a surface.

### BACKGROUND OF THE INVENTION

During winter, snow and ice accumulation on surfaces such as pedestrian walkways and vehicle driveways present potentially hazardous conditions, especially if the surfaces are frequently used. In areas of frequent snowfall and icy conditions, snow and ice removal by mechanical or chemical methods can be expensive requiring investment in equipment. Mechanical and chemical removal means can often damage the surface, and may leave behind residual materials such as salt and sand, which require clean up once winter is finished. There are times when controlled and continual ice and snow removal would be advantageous, such as during a period of heavy snowfall.

To solve this problem, many types of snow and ice removers are available. Heating mats are well known and are used to good effect in maintaining ice and or snow free conditions on surfaces. Conventionally, before ice and or snow begin to accumulate, a user places one or more heating mats on the surface and connects them to an electrical power source. The power source, normally a household supply, powers the heating mats to heat the surface thereby melting the snow or ice. The power source can be timed to power on at certain predetermined time of the day to maintain snow or ice-free conditions. Other types of surface heaters, such as those that can be permanently impregnated into surface materials, such as concrete or asphalt, are available. In this case, the surface heaters may be a mesh of electrical heating cables, heating pipes and the like that are imbedded in the surface materials during construction.

There are a number of important drawbacks associated with heating surfaces using the surface heaters of the types described above. Disadvantageously, heating mats are energy inefficient, relying on a continual supply of electricity from the household source, which if the mats are left on for an extended period of time, can be expensive. In addition, there may be times when only a small area needs to be de-iced, for example, at a remote part of the driveway. Heating mats, such as those described above would not be able to do this without repositioning the mat. In current designs, it is not possible to isolate and de-ice or de-snow a particular area of the heating mat. Furthermore, the electrical resistance of the heating elements limits the total surface area covered by the heating mats, using conventional household power supply and without modifying the latter; which proves to be impractical when relatively large driveways need to heated up.

Thus there is a need for a surface heater that is inexpensive to use, is energy efficient, and is able to remove snow and ice from a predetermined area while making efficient usage of the available power.

### SUMMARY OF THE INVENTION

The present invention reduces the difficulties and disadvantages of previously known surface heaters by providing a surface heater, which is energy efficient and can selectively de-ice or de-snow a predetermined area. The surface heater provides a novel and simple means of alternating heating over a predetermined area that is connectable to a household power source. This reduces electrical resistance, thereby enabling longer and/or wider heating mats to be used. The surface heater is easily adaptable to most surfaces and since the heaters are electrically independent of each other, they can be independently selected should a particular area need more de-icing than another area.

In a first aspect of the invention, there is provided a heating device for heating a surface, the surface defining a plurality of predetermined areas, the heating device being electrically connectable to a power source, the heating device comprising: heating means in communication with the surface for communicating heat to the surface, the heating means including a plurality of heaters, each of the heaters covering the respective predetermined areas, the heaters being electrically independent from one another; alternating means for alternately powering the heating means, the alternating means being electrically connected to the plurality of heaters and for electrically connecting to the power source, the alternating means alternately powering the heaters at a selected time interval so as to alternately heat each of the respective predetermined areas of the surface.

Typically, the heating means includes at least one heater mat, at least two of the plurality of heaters being embedded into the at least one heater mat.

In another aspect of the invention, the heating means includes at least two heater mats, at least one of the plurality of heaters being embedded into each of the heater mats.

Typically, the heating device above, further includes a hazard protecting means electrically connected in series with the alternating means and the power source, the hazard protecting means protecting against a potentially dangerous current consumption of the heating device from the power source.

Typically in the heating device above, at least one of the heaters includes a plurality of resistive elements, the resistive elements electrically connecting in parallel to one another.

Typically, the alternating means includes a power inlet for connecting to the power source; a plurality of power outlets, each of the power outlets electrically connecting to the respective heater; and an alternating circuit electrically connecting to the power inlet and the plurality of power outlets, the alternating circuit alternately connecting the respective power outlets to the power inlet at the selected time interval. The alternating means further includes a control circuit electrically connected to the alternating circuit for controlling the alternating circuit, and a user interface electrically connecting to the control circuit so that a user selects the selected time interval of the alternating circuit.

Typically, the heating device above, further includes a hazard protecting means for protecting against a potentially dangerous current consumption of the heating device from the power source, the hazard protecting means electrically connected in series with the alternating circuit and the power source, the hazard protecting means being integral with the alternating means. The selected time interval includes a powering sequence of the plurality of heaters and a plurality of time durations for alternately powering the respective. heaters, the user interface allowing the user to select the powering sequence and the plurality of time durations of the alternating circuit.

In a second aspect of the invention, there is provided a method for heating a surface using energy provided by an electrical power source, the surface defining a plurality of predetermined areas, the method comprising: alternately powering, at a selected time interval, each of a plurality of heaters, the heaters covering the plurality of predetermined areas, so as to alternately heat each of the respective predetermined areas of the surface.

Other objects and advantages of the present invention will become apparent from a careful reading of the detailed description provided herein, with appropriate reference to the accompanying drawings.

### BRIEF DESCRIPTION OF THE DRAWINGS

Embodiments of the present invention will now be disclosed by way of examples, in reference to the following drawings in which like reference characters indicate like elements throughout.

FIG. 1, is a partially exploded perspective view of a heating device with a heating pad partially peeled back, in accordance with an embodiment of the present invention;

FIG. 2 is a schematic diagram representation of a heating device in accordance with an embodiment of the present invention;

FIGS. 3a, 3b and 3c are other schematic representations showing alternating configurations of heaters;

FIG. 4 is a schematic diagram of another embodiment of a heating device;

FIG. 5 is a perspective view of a second embodiment of the invention;

FIG. 6 is a partially exploded perspective view of a third embodiment of the invention; and

FIG. 7 is a partially exploded perspective view of a fourth embodiment of the invention.

### DETAILED DESCRIPTION OF THE PREFERRED EMBODIMENTS

With reference to the annexed drawings the preferred embodiments of the present invention will be herein described for indicative purpose and by no means as of limitation.

As a general consideration, it should be noted that the figures do not necessarily show the exact proportion of the dimension of the different components illustrated therein. Some dimensions may have been voluntarily exaggerated for clarity purposes only.

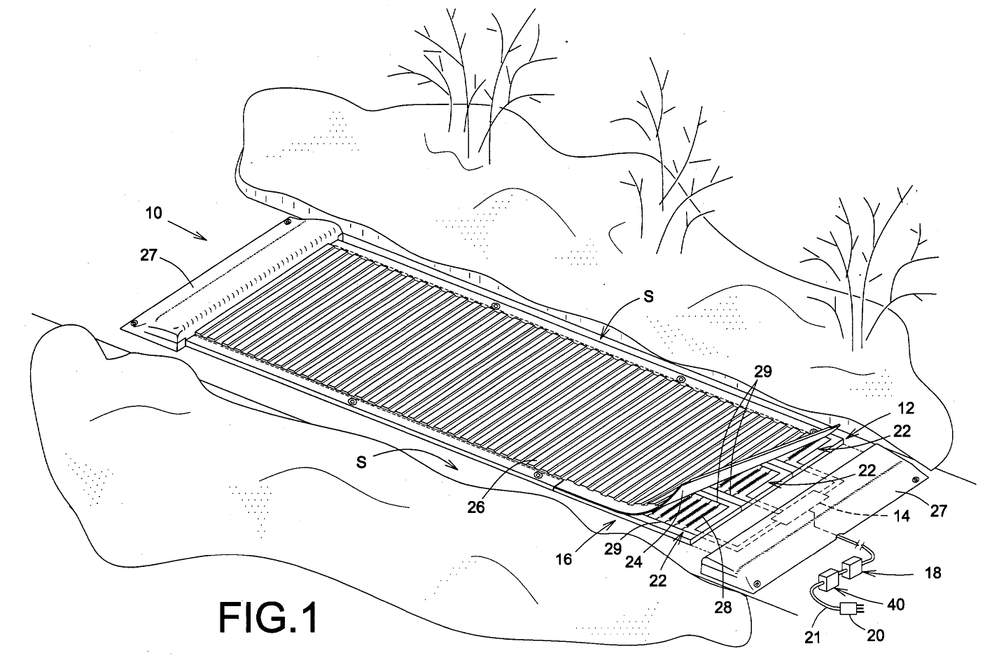

With reference now to FIG. 1, there is shown a first embodiment of a heating device 10 for heating a surface S, which defines a plurality of predetermined areas. Generally speaking, the heating device 10 includes a heating means 12, an alternating means 14, a heating pad (or mat) 16, and a user interface 18. The heating device 10 is electrically connectable to a power source 20 via a power cable 21.

The power source 20 is an electrical power source that is available from any conventional AC outlet (not shown) of a household or the like.

The heating means 12 is in communication with the surface S and when in operation, communicates heat to the surface S to melt accumulated snow and/or ice. One skilled in the art will understand that the surface S to be heated may be the heating pad 16 or, if the heating device is positioned under the surface S, such as flagstones, the top of the surface S may be heated from below. The heating means 12 may also be embedded in the surface material such that the surface material is heated from within. In this embodiment, the heating means 12 generally includes a plurality of heaters 22, schematically represented by resistors, embedded in a lower face 24 (for ease of illustration, FIG. 1 shows the heating mat 16 partially peeled back from the heaters 22) of the heating mat 16. The combined heating mat 16 and the heaters 22 cover the predetermined areas. The elongated heaters 22 are preferably positioned on a side-by-side relationship relative to each other along their longitudinal edges so as to substantially minimize any free space there between and are all electrically independent of each other. All heaters 22 are electrically connected to the alternating means 14. Whenever applicable, the alternating means 14 is also embedded within the heating mat 16 or within one of its end brackets 27, as illustrated in FIG. 1.

The heating mat 16 has an upper portion that has imprinted thereon a non-skid pattern 26. In this case, the non-skid pattern 26 is a series of parallel ridges and valleys that further aid drainage. Many more non-skid patterns are known to those skilled in the art. Typically the heating mats 16 are made of elastomeric materials such as fiber reinforced rubber or rubber-like vulcanized polymers, which provide mechanical strength and durability, and are terminated at their longitudinal ends by end brackets 27 for sealing off and tapering off the respective edges and including any electrical wiring and the like electrical equipment connected to the heaters 22. Although not shown, the heating mats 16 could alternatively be made out of concrete material or the like rigid materials, or any other suitable material that could be laid on or under a surface S and preferably attached thereto whenever required.

Each of the heaters 22 includes a plurality of electrical resistive elements 28, which are electrically connected in parallel to one another via conductors or bus bars 29. In addition, the resistive elements 28, conventionally called heating or heat dissipating elements, transform the electrical energy supplied by the power source 20 into thermal energy. The resistive elements 28 could be of any known type of electrical elements such as electrical resistors, resistive ink, resistive wire, carbon loaded material, carbon filled materials, conductive polymers or the like. Obviously, the heaters 22 can be enclosed inside a mat as shown throughout the figures or inside cables that are laid out in a serpentine or any other suitable fashion (not shown) without departing from the scope of the present invention.

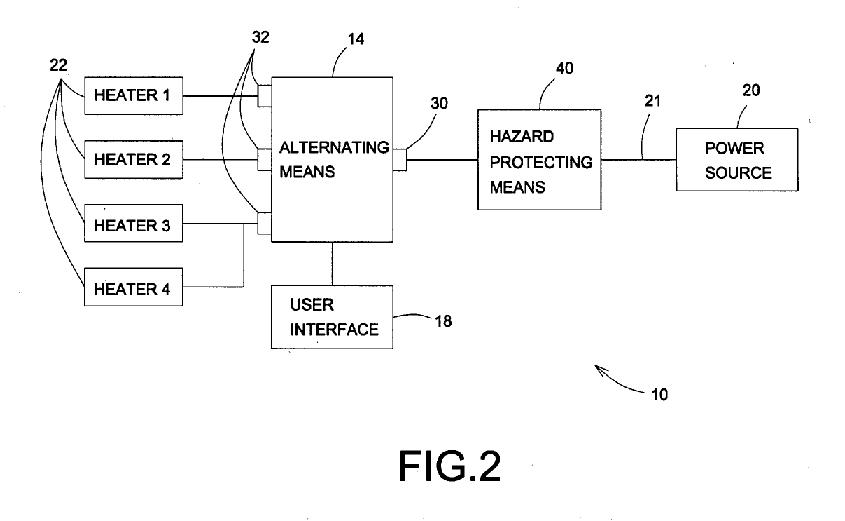

Referring to FIGS. 1 and 2, the alternating means 14 is electrically connected to the heaters 22 and alternately powers the different heaters 22, by alternately electrically connecting and disconnecting each of the heaters 22, or selected group of heaters 22, to the power source 20, one after the other on a time basis. The alternating means 14 is preferably controlled by the user interface 18, which the user may set to alternately power the heaters 22, or selected group of heaters 22, at selected time intervals so as to alternately heat each of the respective predetermined areas of the surface S; for example heaters 22 could be alternately powered on for five (5) or ten (10) minutes each depending on the specific needs. The user interface 18 preferably includes a conventional keypad and display or the like (not shown) and may include a conventional time controller 19 connected in series with the resistive elements 28.

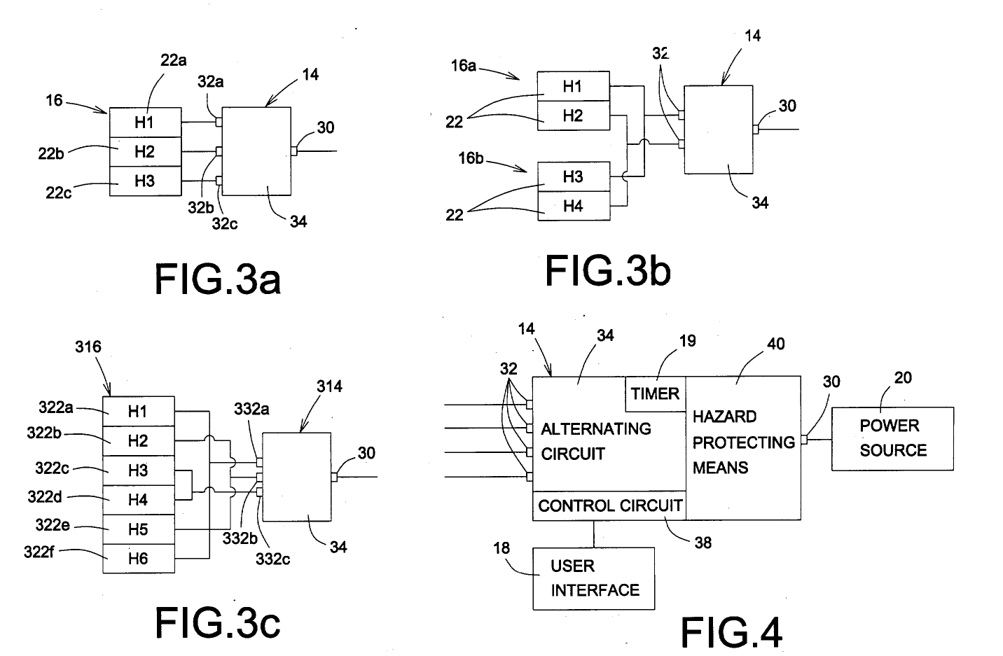

As best illustrated in FIGS. 2, 3a, 3b, and 3c, the alternating means 14 includes a power inlet 30, multiple power outlets 32 and an alternating circuit 34, which will be described in more detail below. The power inlet 30 is connectable to the power source 20, while each of the power outlets 32 electrically connects to an individual heater 22 (shown as heaters H1, H2 in FIG. 2), or selected group of heaters 22 (shown as heaters H3, H4 in FIG. 2). The alternating circuit 34 electrically connects to the power inlet 30 and the plurality of power outlets 32. The alternating circuit 34 alternately electrically connects the power outlets 32 to the power inlet 30 at the selected time interval. The alternating circuit 34 performs the alternating connections via a preferably fully electronic system, although it is well known that other types of system such as a semi-mechanical system could be used without departing from the scope of the present invention.

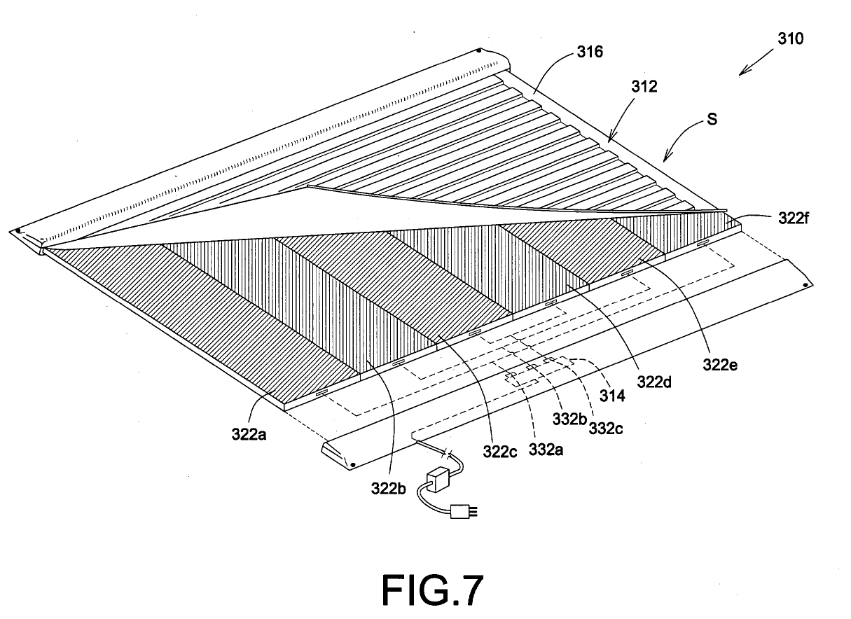

In FIG. 3a, each one of the power outlets 32a, 32b, 32c is connected to a respective one of the heaters 22a, 22b, 22c embedded in a same heating mat 16, as illustrated in FIG. 1. The heating device of FIG. 3b includes two heating mats 16a, 16b, each embedding two heaters 22. Each power outlet 32 of the alternating means 14 is electrically coupled to one of the heaters 22 of each heating mat 16a, 16b so as to always have substantially half of each heating mat 16a, 16b heating up the corresponding predetermined area of the surface S, as it could be convenient for the two left and right wheel paths of a typical driveway. As illustrated more specifically in FIG. 3c, a same heating mat 316 could include six heaters 322a-322f positioned longitudinally side-by-side so as to cover a generally long and wide surface S, as illustrated in FIG. 7. The six heaters 322a-322f, grouped two by two from the opposed outermost ones to the opposed innermost ones, are respectively connected to the three power outlets 332a, 332b, 332c so as to alternately heat up different predetermined areas of the entire surface S.

The alternating means 14 also includes a control circuit 38 electrically connected to the alternating circuit 34 and to the user interface 18 for controlling operation of the alternating circuit 34. Accordingly, a user could modify the selected time intervals for which the alternating circuit 34 connects to each one of the successive power outlets 32.

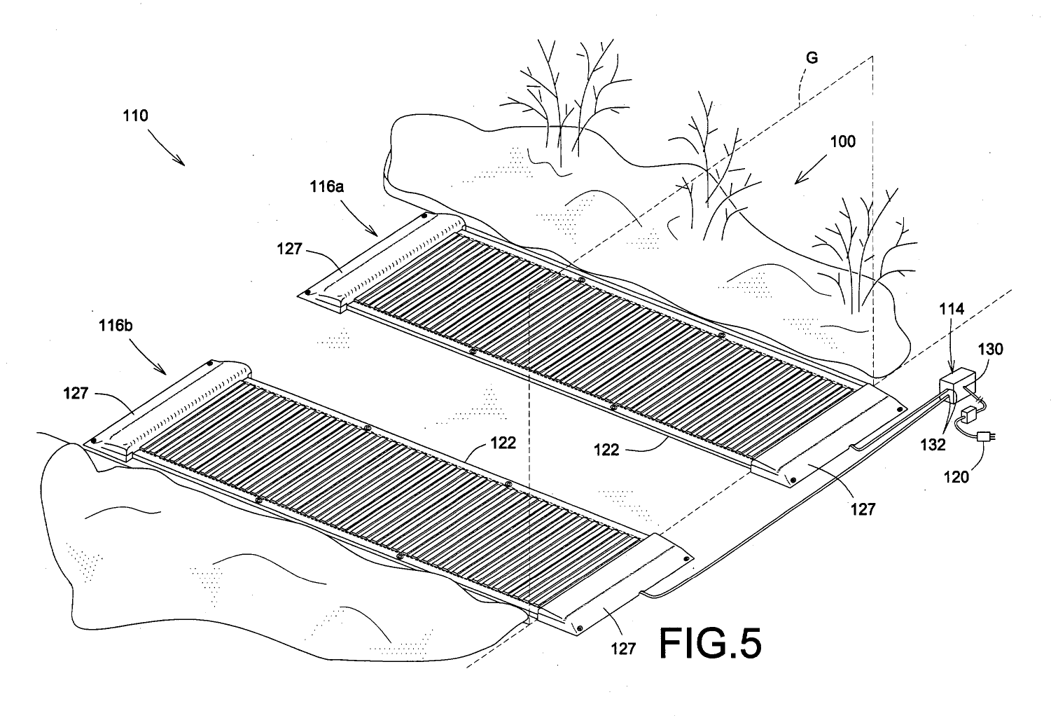

FIGS. 1, 2 and 4 show a hazard protecting means 40, which protects either a human being or the like against any potentially dangerous current consumption of the heating device 10 from the power source 20 or the heating device 10 against any potential damage that could be caused by a power surge at the power source 20. The hazard protecting means 40 is preferably electrically connected in series with the alternating circuit 34 and the power source 20. The hazard protecting means 40 may be integral with the alternating means 14 as shown in FIG. 4 or it may be independent as illustrated in FIG. 1, as it is well known in the art. Specific hazard protecting means are known to those skilled in the art and may include a thermal cutout switch that is electrically connected in series with the alternating circuit, an equipment, leakage circuit interrupter (ELCI) or a ground fault circuit interrupter (GFCI) or a conventional electrical fuse. The latter two are electrically connected in series with the heaters 22 and are located in the power supply cable connecting the heaters 22 to the electrical power supply 20. The GFCI protects the user against inadvertent electric shock if the heaters 22 are damaged by for example a shovel (not shown).

Although the alternating circuit 34 switches power to a different power outlet 32 at a default selected time interval, for example every five (5) minutes, using the interface 18, the selected time interval can be modified by a user upon any specific need. Such a selected time interval includes a powering sequence of the plurality of heaters 22 via the power outlets 32 and a plurality of different time durations for alternately powering the respective power outlets 32. The user interface 18 typically enables the user to set the powering sequence as well as the plurality of time durations such that at the predetermined time intervals, the alternating circuit 34 switches power to another power outlet 32.

Furthermore, the user interface 18 could allow for the voluntarily deactivation of one or more of the power outlets 32 depending on the number of heaters 22 or group of heaters 22 connected to the alternating circuit 34 and used in conjunction therewith.

Depending of the type and/or size of heaters 22 considered, the typical selected time interval regulated by the alternating circuit 34 could range from milliseconds to minutes and even hours without departing from the scope of the present invention.

In embodiments without user interface 18, the selected time interval including the powering sequence and the time duration would be preset at the factory, for standard application and heater sizes.

Operation

As illustrated in FIG. 1, the heating device 10 of the invention is normally supplied independent of the power source 20. Depending upon the extent of the area to be heated, the user selects the appropriate size of the heating mat 16 and pre-sets the time intervals and the powering sequence using the user interface 18. The alternating circuit 34 then alternatively powers each of the heaters 22, such that the predetermined area under the heating mat 16 or on the heating mat heats up and melts the snow and ice accumulated thereupon.

To better illustrate a use of the present heating device 10, lets assume that a standard 115 VAC household power outlet can provide enough power to only one heating mat 16 of the length as represented in FIG. 5, which covers the tire tracks of a driveway, due to the typical current (or power) rating of the 115 VAC household power outlet. In case a user would need two of those heating mats 116a, 116b, one on each side of a driveway facing a garage door G (shown in phantom lines in FIG. 5), since one could not connect both heating mats 116a, 116b to that same standard 115 VAC household power outlet, the user would then need to rewire the house to provide for an additional independent 115 VAC power outlet, which is expensive and cumbersome. The present heating device 110 would enable the user to connect both heating mats 116a, 116b to respective power outlets 132 of the alternating means 114 which would have the power inlet 130 connected to the 115 VAC household power 120. By alternately powering the two heating mats 116a, 116b, the heating device 110 allows the use of the two heating mat configuration.

As illustrated in FIG. 5, the alternating means 114 could be separate from either heating mat 116a, 116b or their end brackets 127 so as to allow external connection of a plurality of heaters thereto.

With the alternating means 14, a multiple heater configuration can be used to wisely and efficiently distribute the heat over the surface S by alternately powering the different heaters 22, depending on their respective size (power consumption rating) and location on the surface S, so as to efficiently make usage of the available power.

Clearly, the heating device 10 of the present invention significantly increases the overall surface area available to the heating mats 16 when compared to conventional heating mats configurations. The heating device 10 therefore allows for a more efficient usage and distribution of the amount of power supplied by a power source 20.

Alternatives

There may be times when snow or ice accumulation might be more prevalent in one area than another, for example a certain part of a walkway may be more exposed to the elements and may attract more ice or snow. The user's knowledge of this as well as a voluntary more emphasized heating of specific predetermined areas would enable him to select an alternative embodiment of the present invention, such as one of the following embodiments illustrated in FIGS. 5 to 7.

Similarly, to modify the time intervals with the embodiment 10 of FIG. 1, it could be possible for the two outermost heaters 22 to be powered simultaneously for a first time interval while the middle heater 22 would be alternately powered with the other two for a second time interval.

FIG. 5 shows a second embodiment of the heating device 110 of the present invention. The heating device 110 is constructed in essentially the same way as the first embodiment 10 and operates in essentially the same way as the first embodiment 10. The heating device 110 includes two heaters 122 that are embedded in a respective heating mat 116a, 116b. Each of the two heaters 122 are electrically connected to an alternating means 114 powered by a power source 120 (illustrated by the power plug). The latter 120 being physically independent form the heating mats 116a, 116b connected thereto.

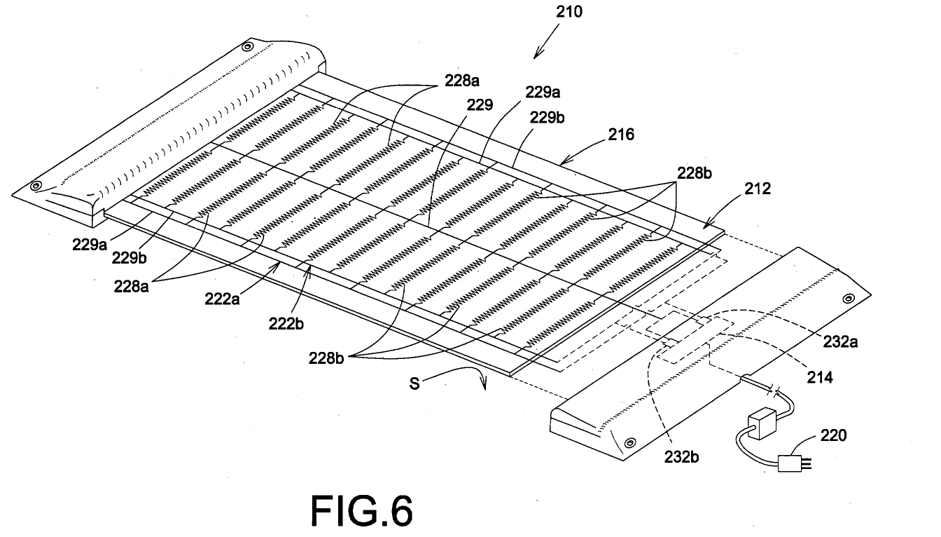

FIG. 6 shows a third embodiment of the heating device 210 of the present invention. Alternatively, a heating means 212 includes at least two heaters 222a, 222b embedded within a single heating mat 216. The resistive elements 228a of the two one heater 222a are positioned in an alternating relationship relative with the resistive elements 228b of the other heater 222b so as to heat substantially most of the surface S at any given time, with a more uniform pattern. An alternating means 214, typically embedded within the heating mat 216 covering wider surfaces, alternately supplies power from the power source 220 to the heaters 222a, 222b.

Furthermore, the respective pairs resistive elements 228a, 228b of the two heaters 222a, 222b are electrically connected to the alternating means 214 using a common central bus bar 229 connected to both power outlets 232a, 232b and respective pairs of lateral bus bars 229a, 229b, each pair being connected to a respective power outlet 232a, 232b. The common central bus bar 229 runs centrally along the heating mat 216 for feeding alternate pairs of resistive elements 228a, 228b while each lateral bus bar 229a, 229b runs along both lateral edges of the heating mat 216, while being electrically independent from each one another.

Although not expressly illustrated, only heater 222a of FIG. 6 could be present and divided into two heaters with the respective lateral bus bars 229a connected to different power outlets 232a and the central bus bar 229 connected to both power outlets 232a of the alternating means 214. In this case, the alternating would be done between the lateral conductors 229a located at the lateral edges of the heating mat 216 to alternately heat up each half thereof.

FIG. 7 shows a fourth embodiment of the heating device 310 of the present invention being even wider than the third embodiment 210. Alternatively, a heating means 312 includes at six heaters 322a, 322b, 322c, 322d, 322e, 322f embedded within a single heating mat 316. The heaters 322a to 322f are connected into three groups of two, preferably, the two outermost heaters 322a, 322f together, the two innermost heaters 322c, 322d together and the remaining two heaters 322b, 322e together; each group being connected to a respective power outlet 332a, 332c, 332b of the alternating means 314 for alternate heating of successive predetermined areas of the surface S.

The present invention also provides for a method for heating a surface S using energy provided by an electrical power source 20, the surface S defining a plurality of predetermined areas. The method comprises the step of alternately powering, at a selected time interval, each of a plurality of heaters 22, the heaters 22 being in communication with the plurality of predetermined areas for communicating heat to the plurality of predetermined areas, respectively, so as to alternately heat each of the respective predetermined areas of the surface S.

Typically, the method further includes the step of providing a plurality of heaters 22, each heater 22 covers the respective predetermined area, the heaters 22 being electrically independent from one another.

By alternately powering the heaters 22, the method typically refers to providing an alternating circuit 34, the alternating circuit 34 including a power inlet 30 and a plurality of power outlets 32; and electrically connecting the power inlet 30 to the power source 20 and each of the power outlets 32 to the respective heater 22, or group of selected heaters 22, the alternating circuit 34 alternately connecting the respective power outlets 32 to the power inlet 30 at the selected time interval.

The step of alternately powering the heaters 22 further includes interfacing with a control circuit 38, preferably via-a user interface 18, so as to select the selected time interval of the alternating circuit 34, the control circuit 38 electrically connecting to the alternating circuit 34.

Although not specifically illustrated herein, it would be obvious to one skilled in the art to use different types of sensors, such as humidity sensor, temperature sensor, light sensor, etc. in conjunction with the present surface heating device 10 without departing from the scope of the present invention. Such sensors could obviously be series connected to the alternating means 14 between the latter and the power source 20, or be embedded within the alternating circuit 34 or the control circuit 38.

Although the present surface heating device and method have been described with a certain degree of particularity, it is to be understood that the disclosure has been made by way of example only and that the present invention is not limited to the features of the embodiments described and illustrated herein, but includes all variations and modifications within the scope and spirit of the invention as hereinafter claimed.

I claim:

1. A heating device for heating a surface, said surface defining a plurality of predetermined areas, said heating device being electrically connectable to a power source, said heating device comprising:
heating means in communication with the surface for communicating heat to the surface, said heating means including a plurality of heaters, each of said heaters covering the respective predetermined areas, said heaters being electrically independent from one another;
alternating means for alternately powering said heating means, said alternating means being electrically connected to said plurality of heaters and for electrically connecting to said power source, said alternating means alternately powering said heaters at a selected time interval so as to alternately heat each of said respective predetermined areas of the surface.

2. The heating device of claim 1 wherein said heating means includes at least one heater mat, at least two of said plurality of heaters being embedded into said at least one heater mat.

3. The heating device of claim 1 wherein said heating means includes at least two heater mats, at least one of said plurality of heaters being embedded into each of said heater mats.

4. The heating device of claim 1, further including a hazard protecting means electrically connected in series with said alternating means and the power source, said hazard protecting means protecting against a potentially dangerous current consumption of said heating device from the power source.

5. The heating device of claim 1 wherein at least one of said heaters includes a plurality of resistive elements, said resistive elements electrically connecting in parallel to one another.

6. The heating device of claim 1 wherein said alternating means includes a power inlet for connecting to the power source; a plurality of power outlets, each of said power outlets electrically connecting to said respective heater; and an alternating circuit electrically connecting to said power inlet and said plurality of power outlets, said alternating circuit alternately connecting said respective power outlets to said power inlet at said selected time interval.

7. The heating device of claim 6 wherein said alternating means further includes a control circuit electrically connected to said alternating circuit for controlling said alternating circuit, and a user interface electrically connecting to said control circuit so that a user selects said selected time interval of said alternating circuit.

8. The heating device of claim 7, further including a hazard protecting means for protecting against a potentially dangerous current consumption of said heating device from the power source, said hazard protecting means electrically connected in series with said alternating circuit and the power source, said hazard protecting means being integral with said alternating means.

9. The heating device of claim 7 wherein said selected time interval includes a powering sequence of said plurality of heaters and a plurality of time durations for alternately powering said respective heaters, said user interface allowing the user to select said powering sequence and said plurality of time durations of said alternating circuit.

10. A method for heating a surface using energy provided by an electrical power source, said surface defining a plurality of predetermined areas, said method comprising:
alternately powering, at a selected time interval, each of a plurality of heaters, said heaters being in communication with the plurality of predetermined areas for communicating heat to the plurality of predetermined areas, respectively, so as to alternately heat each of said respective predetermined areas of the surface.

11. The method of claim 10, further including:
providing a plurality of heaters, each of said heaters covering the respective predetermined areas, said heaters being electrically independent from one another.

12. The method of claim 11 wherein said providing a plurality of heaters includes providing at least one heater mat, at least two of said plurality of heaters being embedded into said at least one heater mat.

13. The method of claim 11 wherein providing a plurality of heaters includes providing at least two heater mats, at least one of said plurality of heaters being embedded into each of said heater mats.

14. The method of claim 11 wherein alternately powering said heaters further includes protecting said heaters against a potentially dangerous current consumption thereof from the power source.

15. The method of claim 11 wherein at least one of said heaters includes a plurality of resistive elements, said resistive elements electrically connecting in parallel to one another.

16. The method of claim 11 wherein alternately powering said heaters includes:
providing an alternating circuit, said alternating circuit including a power inlet and a plurality of power outlets; and
electrically connecting said power inlet to the power source and each of said power outlets to said respective heater, said alternating circuit alternately connecting said respective power outlets to said power inlet at said selected time interval.

17. The method of claim 16 wherein alternately powering said heaters further includes interfacing with a control circuit so as to select said selected time interval of said alternating circuit, said control circuit electrically connecting to said alternating circuit.

18. The method of claim 16 wherein alternately powering said heaters further includes protecting said heaters against a potentially dangerous current consumption thereof from the power source.

19. The method of claim 16 wherein said selected time interval includes a powering sequence of said plurality of heaters and a plurality of time durations for alternately powering said respective heaters, and wherein interfacing with a control circuit includes selecting said powering sequence and said plurality of time durations of said selected time interval.

20. A heating device for heating a surface, said surface defining a plurality of predetermined areas, said heating device being electrically connectable to a power source, said heating device comprising:
heating means in communication with the surface for communicating heat to the surface, said heating means including a plurality of heaters, each of said heaters covering the respective predetermined areas, said heaters being electrically independent from one another;
said heating means including at least one heater mat, at least one of said plurality of heaters being embedded into said at least one heater mat;
at least one of said heaters including a plurality of resistive elements, said resistive elements electrically connecting in parallel to one another;
alternating means for alternately powering said heating means, said alternating means including a power inlet for connecting to the power source; a plurality of power outlets, each of said power outlets electrically connecting to said respective heater; and an alternating circuit electrically connecting to said power inlet and said plurality of power outlets, said alternating circuit alternately connecting said respective power outlets to said power inlet at said selected time interval so as to alternately heat each of said respective predetermined areas of the surface.
